(19) United States
(12) Patent Application Publication
(10) Pub. No.: US 2011/0186706 A1
(43) Pub. Date: Aug. 4, 2011

(54) MOUNTING APPARATUS FOR DISK DRIVE

(75) Inventor: YUAN XUE, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/870,633

(22) Filed: Aug. 27, 2010

(30) Foreign Application Priority Data
Jan. 29, 2010 (CN) 201020301859.3

(51) Int. Cl. F16B 45/00; F16M 13/00

(52) U.S. Cl. 248/304; 248/309.1

(57) ABSTRACT

A mounting apparatus includes a chassis, a bracket secured to the chassis, and a locking member. The bracket includes a bottom wall, a first sidewall and a second sidewall. The first and second sidewalls are configured for securing a disk drive therebetween. A securing slot is defined in the first sidewall, configured for receiving a positioning post of the disk drive. The locking member is secured to the bottom wall and the first sidewall. A locking block is located on the locking member for blocking the positioning post in the securing slot.

### BACKGROUND

1. Technical Field

The present disclosure relates to a mounting apparatus for securing a disk drive.

2. Description of Related Art

In a computer system, a disk drive, such as a hard disk drive or a compact disc read-only memory (CD-ROM) drive is needed. So, a mounting apparatus for conveniently securing the disk drive to the computer system is needed, and there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a cutaway, exploded view of a mounting apparatus and a disk drive in accordance with an embodiment.

FIG. 2 is an exploded view of a bracket and a locking member of FIG. 1.

FIG. 3 is an assembled view of FIG. 2.

FIG. 4 is a cutaway, assembled view of the mounting apparatus and the disk drive of FIG. 1.

FIG. 5 is an enlarged view of portion V of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

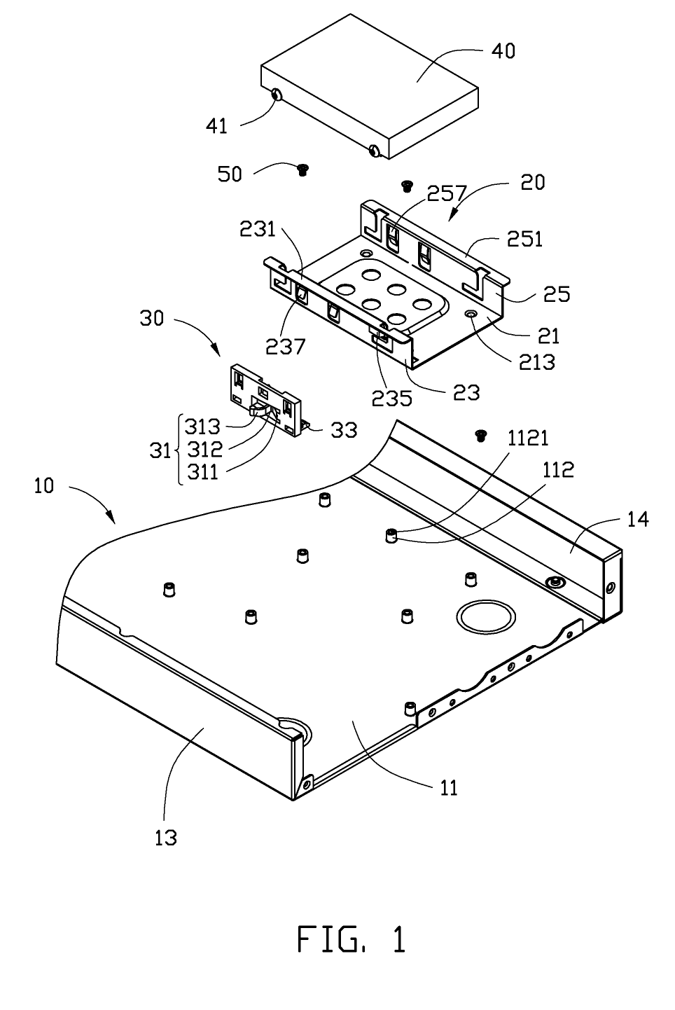

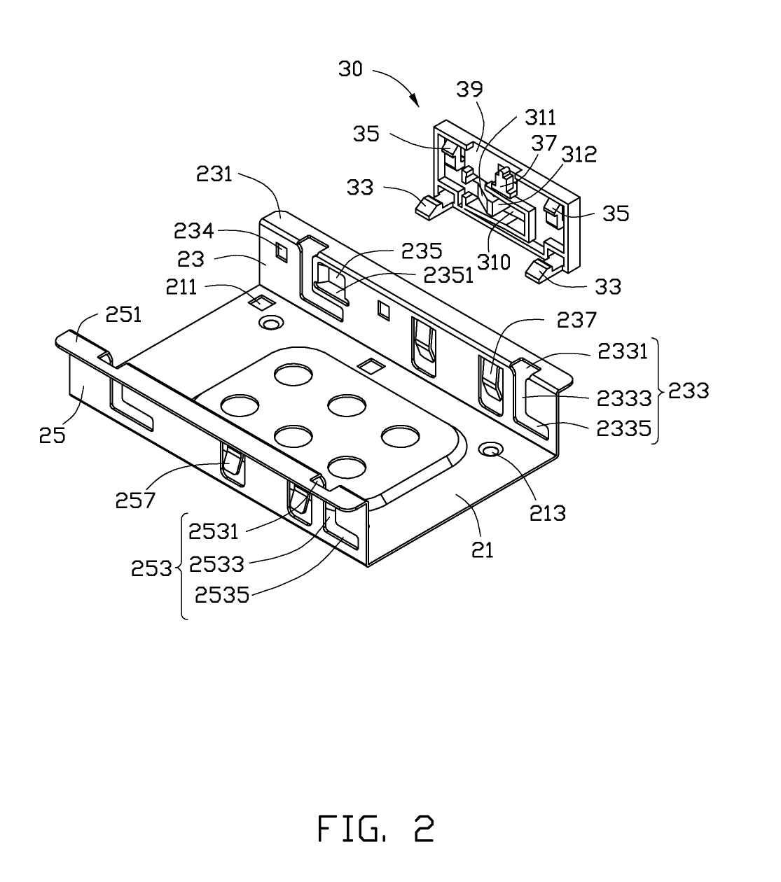

Referring to FIGS. 1-2, a mounting apparatus is configured for securing a disk drive 40. Two positioning posts 41 are located on opposite disk drive walls.

The mounting apparatus in accordance with an embodiment includes a chassis 10, a bracket 20, and a locking member 30.

The chassis 10 includes a bottom plate 11, a first side plate 13, and a second side plate 14. A plurality of mounting posts 112 is located on an inner surface of the bottom plate 11. A mounting hole 1121 is defined in each mounting post 112. The first and second side plates 13, 14 are located on opposite edges of the bottom plate 11.

The bracket 20 includes a bottom wall 21, a first sidewall 23, and a second sidewall 25. A plurality of through holes 213 is defined in the bottom wall 21. Two locking holes 211 are defined in the bottom wall 21 and adjacent the first sidewall 23. A first flange 231 extends out from a top edge of the first sidewall 23. Two first securing slots 233 are defined in the first sidewall 23 and the first flange 231. Each first securing slot 233 includes a first entry 2331, a first vertical portion 2333, and a first horizontal portion 2335. Two securing holes 234 are defined in the first sidewall 23, corresponding to the locking holes 211. One first securing slot 233 is located between the two securing holes 234. A securing clip 235 is disposed on the first sidewall 23 between the two securing holes 234, and a gap 2351 is defined between the securing clip 235 and the first sidewall 23. Two first resilient pieces 237 are located on the first sidewall 23. A second flange 251 extends out of a top edge of the second sidewall 25. Two second securing slots 253 are defined in the second sidewall 25 and the second flange 251. Each second securing slot 253 includes a second entry 2531, a second vertical portion 2533, and a second horizontal portion 2535. Two second resilient pieces 257 are disposed on the second sidewall 25, corresponding to the first resilient pieces 237. In one embodiment, the first sidewall 23 is substantially perpendicular to the bottom wall 21 and parallel to the second sidewall 25, and the first and second flanges 231, 251 are substantially perpendicular to the first and second sidewalls 23, 25 and parallel to the bottom wall 21.

A through slot 310 is defined in the locking member 30. A locking block 31 is disposed on the locking member 30 in the through slot 310. The locking block 31 includes a resilient portion 311, a blocking portion 312 and an operating portion 313. The resilient portion 311 is connected to the locking member 30. The blocking portion 312 is connected between the resilient portion 311 and the blocking portion 312. An angle is defined between the blocking portion 312 and the resilient portion 311. The operating portion 313 is located on a distal end of the blocking portion 312. Two first hooks 33 are located on the bottom of the locking member 30, for engaging in the locking holes 211. Two second hooks 35 above the first hooks 33 are located on the locking member 30. In one embodiment, the first hooks 33 are substantially perpendicular to the second hooks 35. A positioning block 37 is located on the locking member 30 between the second hooks 35, for engaging with the securing clip 235 through the gap 2351. A cutout 39 is defined in a top edge of the locking member 30, and the securing clip 235 can pass through the cutout 39 to engage with the positioning block 37.

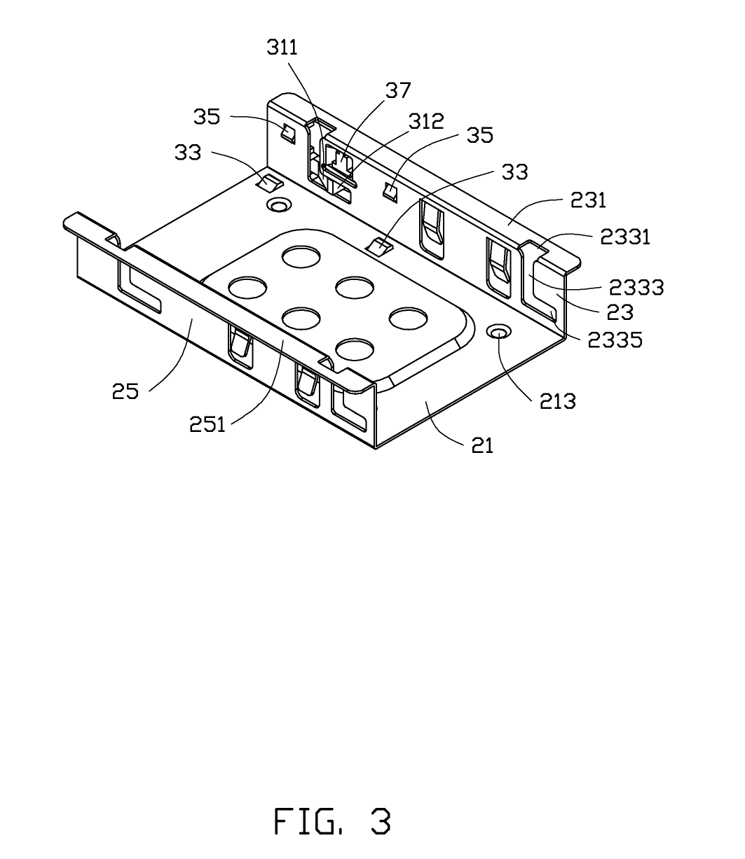

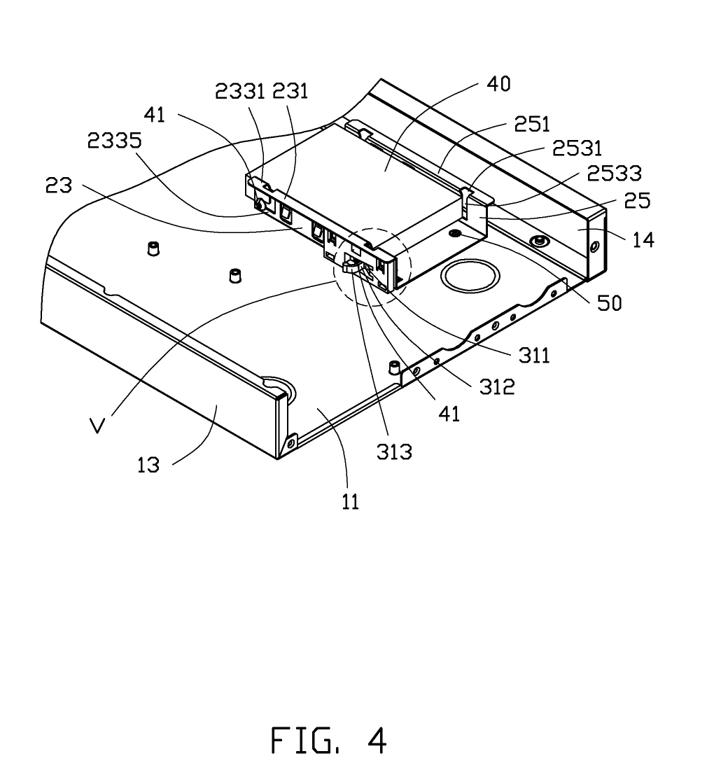

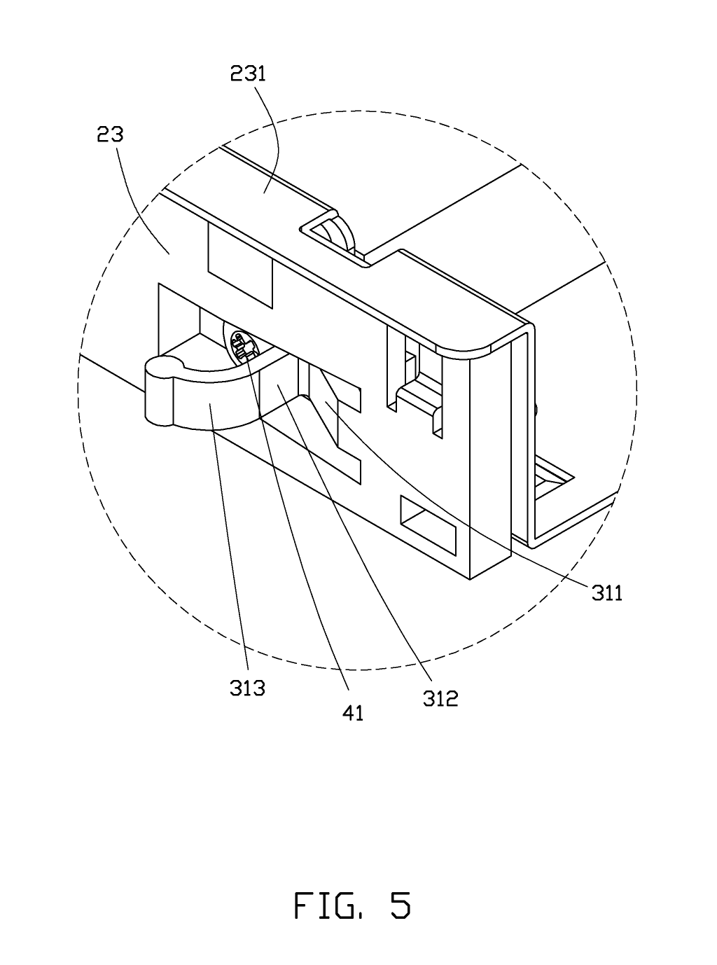

Referring to FIGS. 3-5, in assembly, the first hooks 33 are engaged in the locking holes 211 and the second hooks 35 are engaged in the securing holes 234. The positioning blocks 37 are inserted into the gap 2351 to engage with the securing clip 235. The locking block 31 is positioned in the first horizontal portion 2335 of the corresponding one first securing slot 233 and does not block in the vertical portion 2333. Thus, the locking member 30 is secured to the first sidewall 23.

The bracket 20 is placed in the chassis 10 above the bottom plate 11. The mounting holes 1121 of the mounting posts 112 are aligned with the through holes 213. A plurality of fasteners 50, such as screws, is screwed into the through holes 213 and the mounting holes 1121. Thus, the bracket 20 is secured to the chassis 10.

The disk drive 40 is placed in the bracket 20 between the first and second sidewalls 23, 25. The positioning posts 41 are inserted into the first and second securing slots 233, 253 through the first and second entries 2331, 2531. The disk drive 40 is slid from the first and second vertical portions 2333, 2533 to the first and second horizontal portions 2335, 2535, until one positioning post 41 is blocked by the resilient portion 311 of the locking block 31. The disk drive 40 is further slid to resiliently deform the resilient portion 311 by the one positioning post 41, until the one positioning post 41 can pass through the locking block 31. After the one positioning post 41 passes through the locking block 31, the resilient portion 311 rebounds, and the blocking portion 312 blocks the one positioning post 41 in the corresponding first horizontal portion 2335. The first and second resilient pieces 237, 357 abut the disk drive 40 and are resiliently deformed by the disk drive 40. Thus, the disk drive 40 is secured in the bracket 20.

In disassembly, the resilient portion 311 is resiliently deformed outward by the operating portion 313, until the positioning post 41 is not blocked by the blocking portion 312. Thus, the positioning posts 41 of the disk drive 40 can be slid out of the first and second securing slots 233, 253. Therefore, the disk drive 40 can be removed from the bracket 20.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus comprising:
a chassis;
a bracket secured to the chassis; the bracket comprising a bottom wall, a first sidewall and a second sidewall; the first and second sidewalls are configured for securing a disk drive therebetween; and a securing slot is defined in the first sidewall, configured for receiving a positioning post of the disk drive; and
a locking member secured to the bottom wall and the first sidewall, a locking block located on the locking member for blocking the positioning post in the securing slot.

2. The mounting apparatus of claim 1, wherein the first sidewall is substantially perpendicular to the bottom wall.

3. The mounting apparatus of claim 1, wherein the bottom wall defines a locking hole; the first sidewall defines a securing hole; a first hook and a second hook are located on the locking member; and the first hook is engaged in the locking hole, and the second hook is engaged in the securing hole.

4. The mounting apparatus of claim 3, wherein the first hook is substantially perpendicular to the second hook.

5. The mounting apparatus of claim 3, wherein the securing slot comprises an entry, a vertical portion and a horizontal portion; and the locking block is engaged positioned in the horizontal portion.

6. The mounting apparatus of claim 5, wherein a first flange extends from the first sidewall, and the entry is defined in the first flange.

7. The mounting apparatus of claim 5, wherein the locking block comprises a resilient portion, connected to the locking member, and a blocking portion, located on the resilient portion for blocking the positioning post; and an angle is defined between the resilient portion and the blocking portion.

8. The mounting apparatus of claim 1, wherein a positioning block is located on the locking member; and a securing clip is located on the first sidewall to engage with the positioning block.

9. The mounting apparatus of claim 8, wherein a gap is defined between the securing clip and the first sidewall and receives the positioning block.

10. The mounting apparatus of claim 1, wherein the chassis comprises a bottom plate and two side plates located on the bottom plate; the two side plates are substantially parallel to each other and perpendicular to the bottom plate; and the bracket is secured to the bottom plate and separated from the two side plates.

11. A mounting apparatus comprising:
a bracket comprising a bottom wall, a first sidewall and a second sidewall; the first and second sidewalls are configured for securing a disk drive therebetween; and a securing slot is defined in the first sidewall; the securing slot comprises an entry, a vertical portion and a horizontal portion; the entry is configured for a positioning post of the disk drive inserted in the entry, the vertical portion and the horizontal portion are configured for the positioning post sliding therein; and
a locking member secured to the bottom wall and the first sidewall, a locking block is located on the locking member;
wherein the locking block is positioned in the horizontal portion for blocking the positioning post in the securing slot.

12. The mounting apparatus of claim 11, wherein the first sidewall is substantially perpendicular to the bottom wall.

13. The mounting apparatus of claim 11, wherein the bottom wall defines a locking hole; the first sidewall defines a securing hole; a first hook and a second hook are located on the locking member; and the first hook is engaged in the locking hole; and the second hook is engaged in the securing hole.

14. The mounting apparatus of claim 13, wherein the first hook is substantially perpendicular to the second hook.

15. The mounting apparatus of claim 11, wherein a first flange extends from the first sidewall, and the entry is defined in the first flange.

16. The mounting apparatus of claim 11, wherein the locking block comprises a resilient portion connected to the locking member and a blocking portion located on the resilient portion for blocking the positioning post; and an angle is defined between the resilient portion and the blocking portion.

17. The mounting apparatus of claim 11, wherein a positioning block is located on the locking member; and a securing clip is located on the first sidewall to engage with the positioning block.

18. The mounting apparatus of claim 11, wherein a gap is defined between the securing clip and the first sidewall and receives the positioning block.

19. The mounting apparatus of claim 11, further comprising a chassis, the chassis comprising a bottom plate and two side plates located on the bottom plate; the two side plates substantially parallel to each other and perpendicular to the bottom plate; and the bracket secured to the bottom plate and separated from the two side plates.
